(19) United States
(12) Patent Application Publication
(10) Pub. No.: US 2017/0325401 A1
(43) Pub. Date: Nov. 16, 2017

(54) Blade of string trimmer

(71) Applicant: Chi-Cheng Chang, Talchung (TW)

(72) Inventor: Chi-Cheng Chang, Talchung (TW)

(21) Appl. No.: 15/663,839

(22) Filed: Jul. 31, 2017

(51) Int. Cl. A01D 34/73; A01D 34/90

(52) U.S. Cl. CPC A01D 34/73; A01D 34/90

(57) ABSTRACT

A rectangular blade of a string trimmer is provided. The rectangular blade includes two straight cutting edges, each straight cutting edge including a plurality of cuts which can be either V-shaped or U-shaped. In other embodiments, the blade has a shape different from the rectangle.

### BACKGROUND OF THE INVENTION

### 1. Field of the Invention

The invention relates to string trimmers and more particularly to a blade of a string trimmer having improved characteristics.

### 2. Description of Related Art

A conventional blade 1 of a string trimmer is shown in FIG. 1. However, its straight edge 2 without cuts is liable to become dull due to contact with a harder substance.

Thus, the need for improvement still exists.

### SUMMARY OF THE INVENTION

It is therefore one object of the invention to provide a rectangular blade of a string trimmer comprising two straight cutting edges, each including a plurality of cuts.

The above and other objects, features and advantages of the invention will become apparent from the following detailed description taken with the accompanying drawings.

### BRIEF DESCRIPTION OF THE DRAWINGS

FIG. 1 is a perspective view of a conventional blade of a string trimmer;

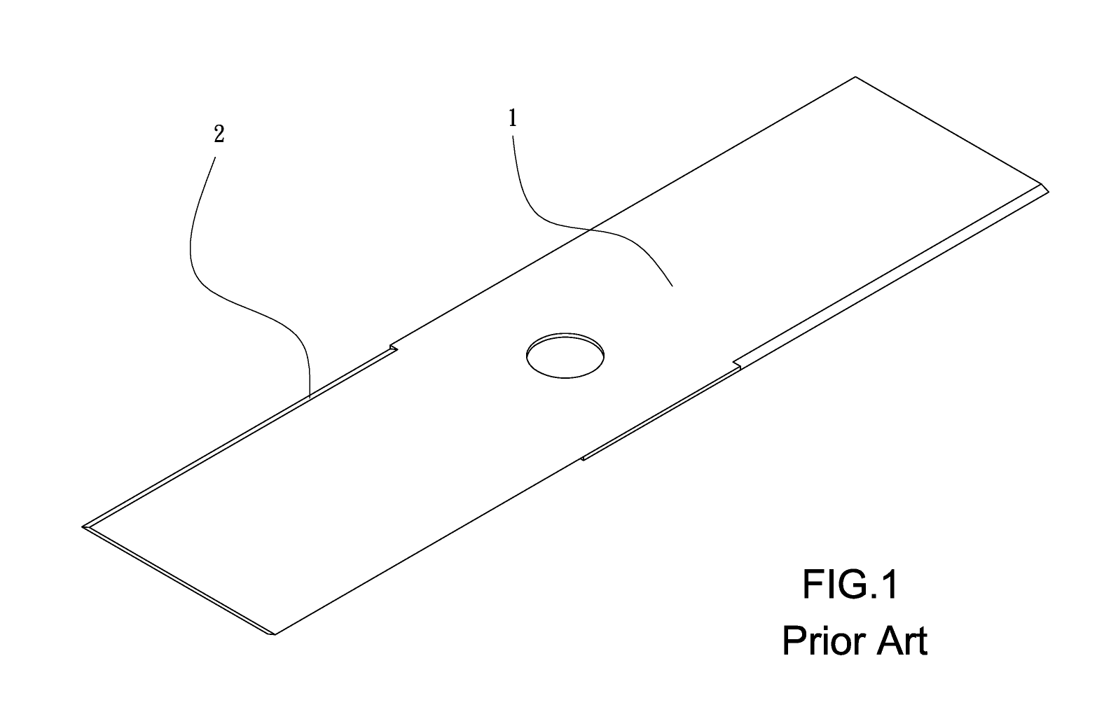

FIG. 2 is a perspective view of a blade of a string trimmer according to a first preferred embodiment of the invention;

FIG. 3 is a top view of the blade of FIG. 2;

FIG. 4 is a perspective view of a blade of a string trimmer according to a second preferred embodiment of the invention;

FIG. 5 is a top view of the blade of FIG. 4;

FIG. 6 is a perspective view of a blade of a string trimmer according to a third preferred embodiment of the invention;

FIG. 7 is a perspective view of four blades of a string trimmer according to a fourth preferred embodiment of the invention;

FIG. 8 is a perspective view of a string trimmer incorporating the blade of the first preferred embodiment; and

FIG. 9 depicts the blade of the first preferred embodiment erecting grass prior to cutting it in operation.

### DETAILED DESCRIPTION OF THE INVENTION

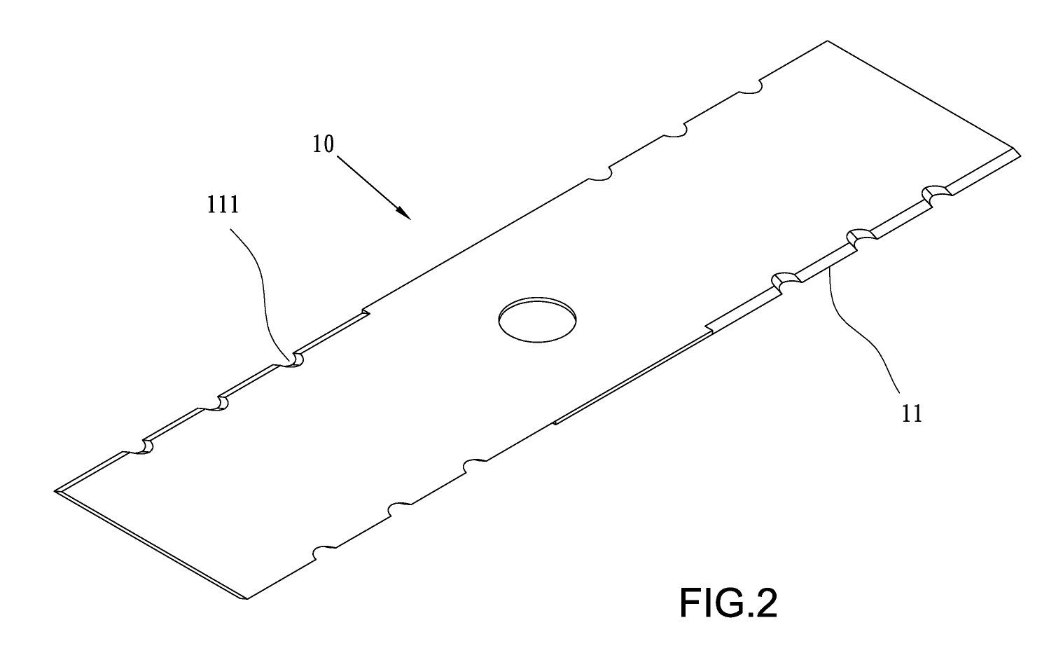

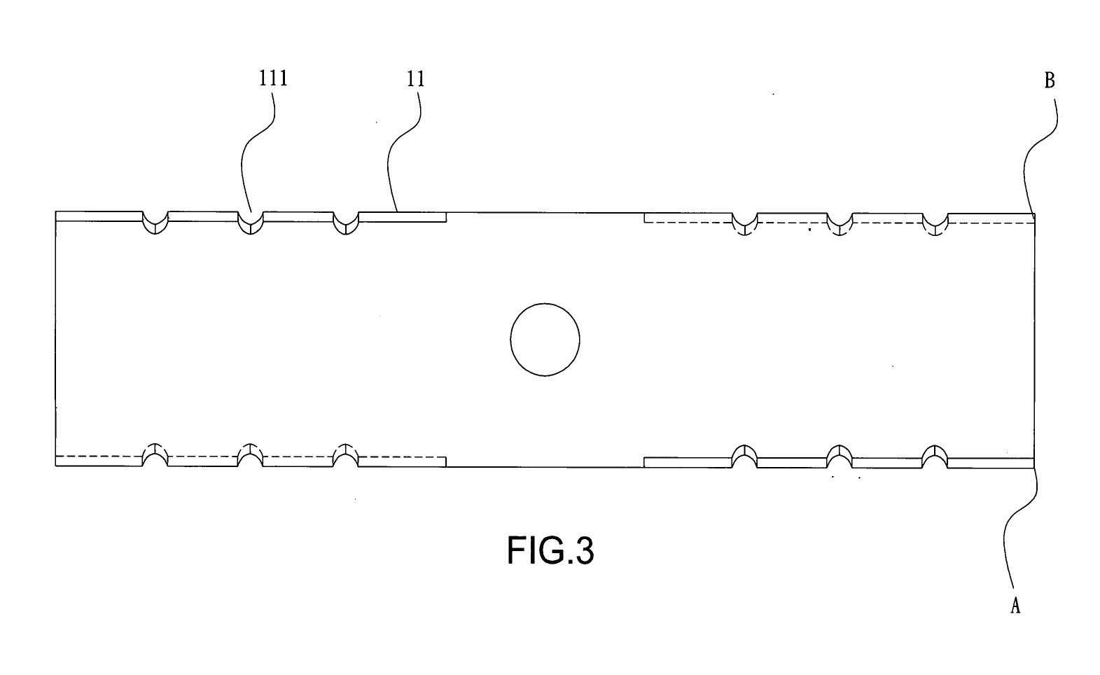

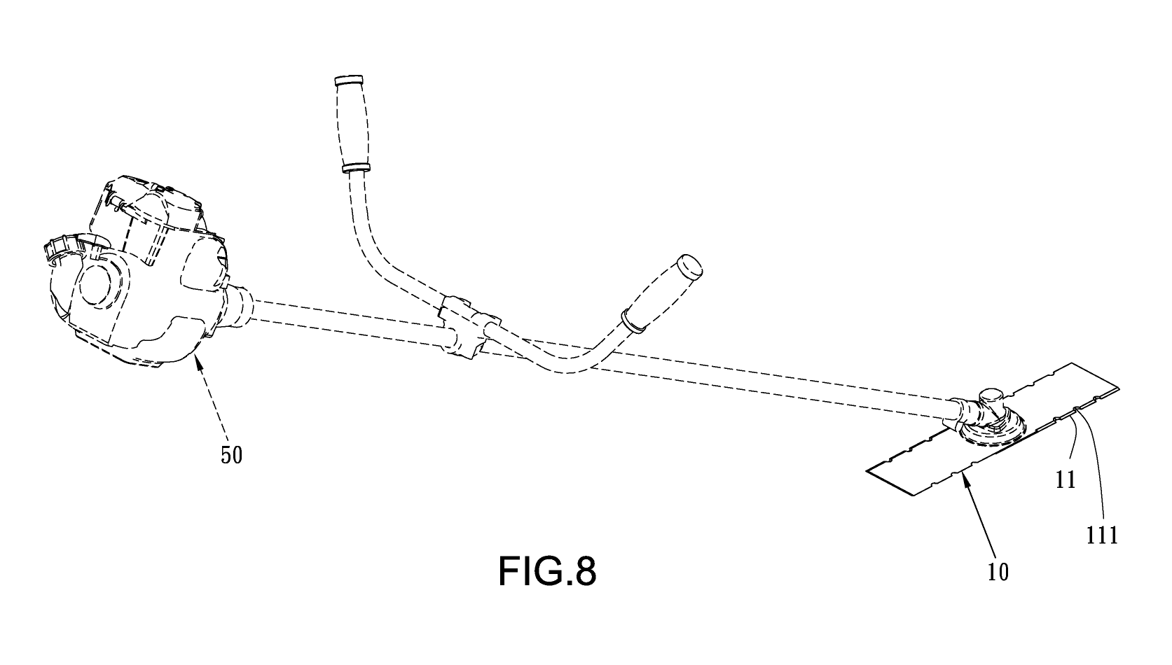

Referring to FIGS. 2, 3 and 8, a rectangular blade 10 of a string trimmer 50 according to a first preferred embodiment of the invention comprises two straight cutting edges 11 each comprising a plurality of cuts 111.

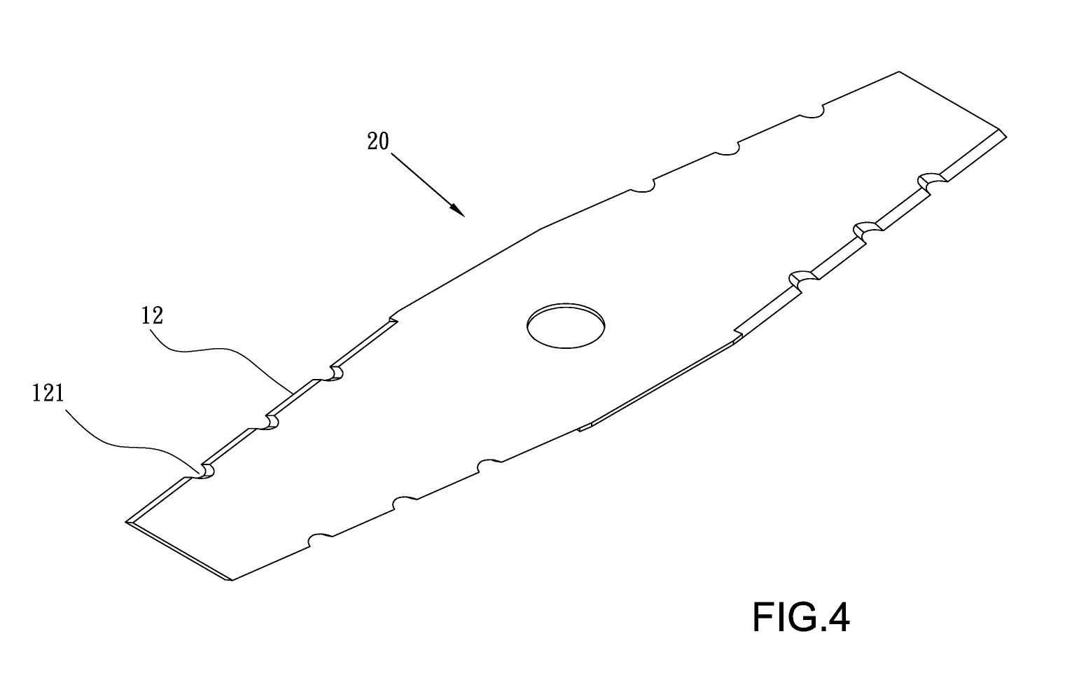

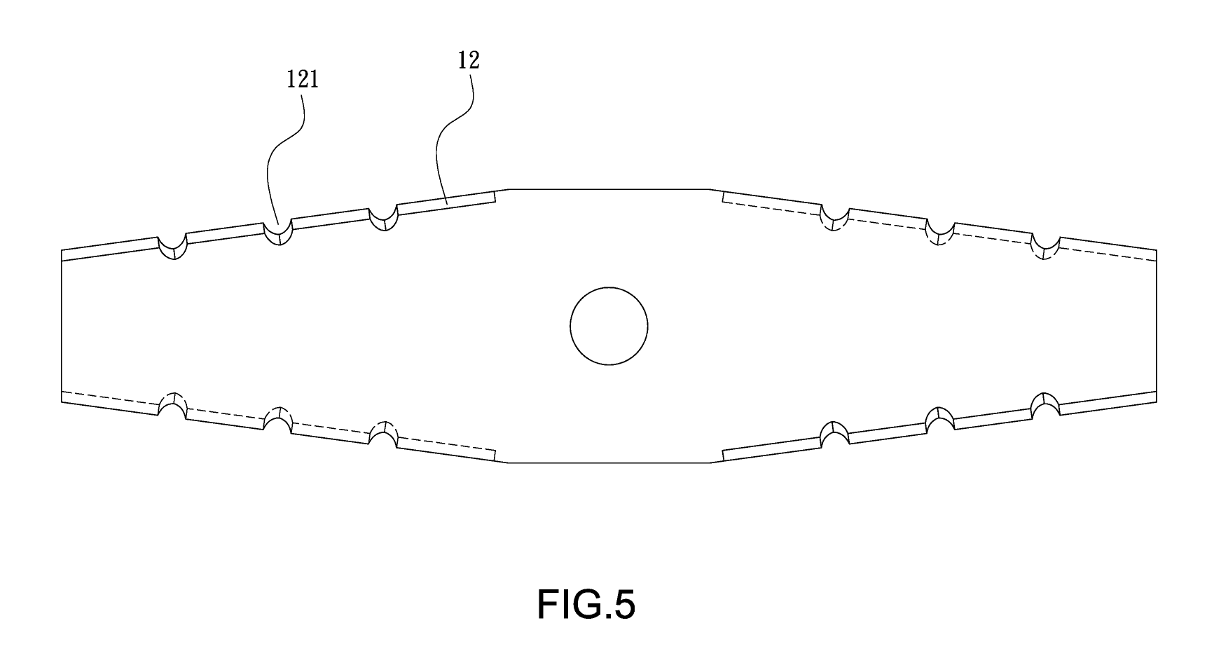

Referring to FIGS. 4 and 5, a quadrilateral blade 20 of a string trimmer according to a second preferred embodiment of the invention comprises four inclined cutting edges 12 each comprising a plurality of cuts 121.

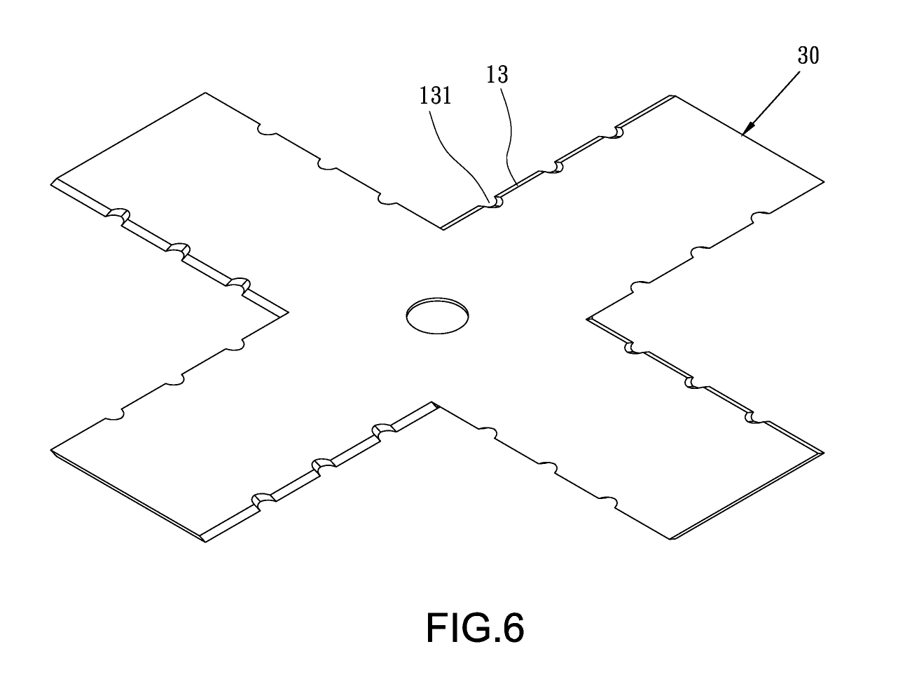

Referring to FIG. 6, a cross-shaped blade 30 of a string trimmer according to a third preferred embodiment of the invention each comprise eight straight cutting edges 13 each comprising a plurality of cuts 131.

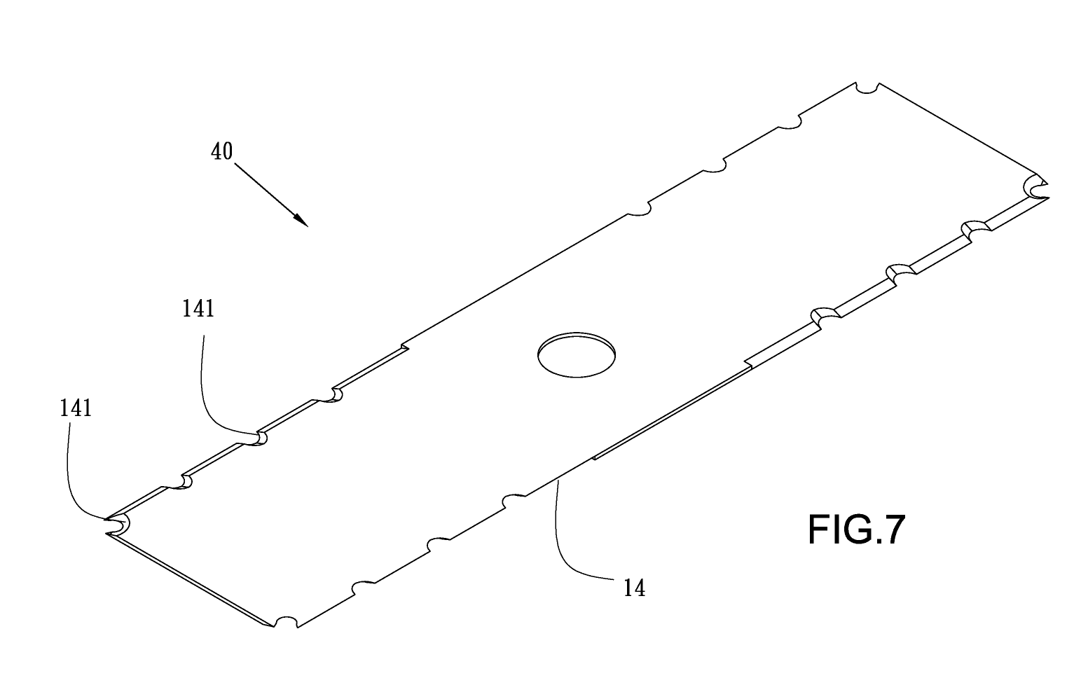

Referring to FIG. 7, a rectangular blade 40 of a string trimmer according to a fourth preferred embodiment of the invention comprises four cuts 141 at four corners respectively, and two straight cutting edges 14 each comprising a plurality of cuts 141.

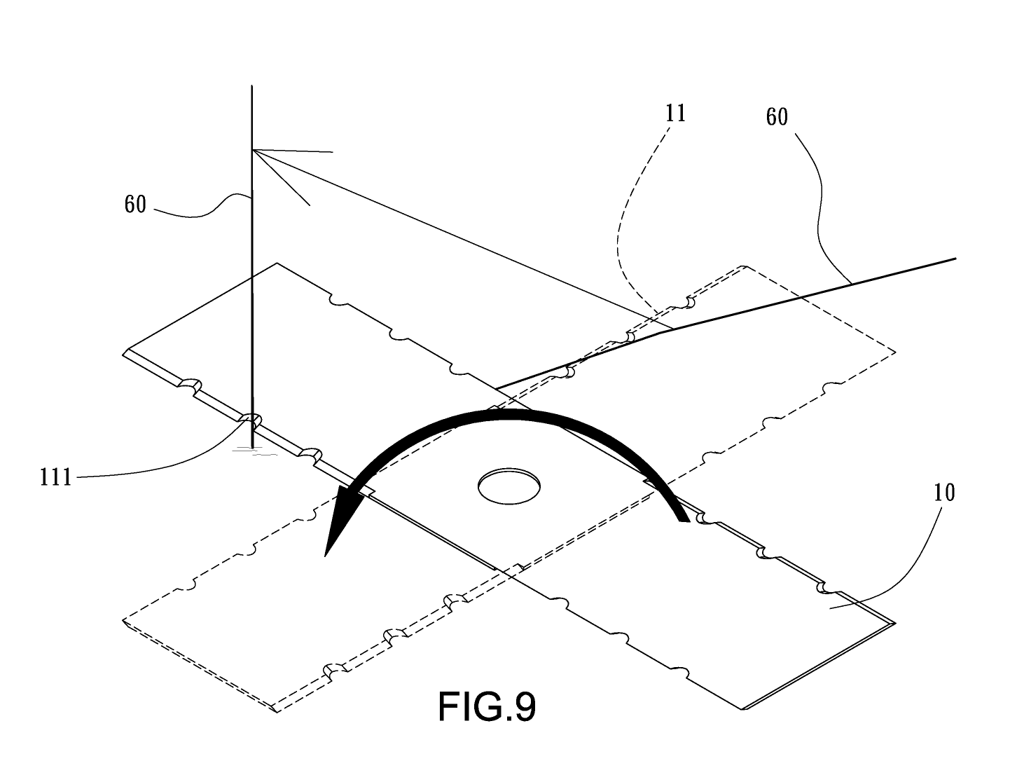

Referring to FIG. 9, the blade 10 uprights grass 60 prior to cutting it in operation.

While the invention has been described in terms of preferred embodiments, those skilled in the art will recognize that the invention can be practiced with modifications within the spirit and scope of the appended claims.

1. A rectangular blade of a string trimmer, the rectangular blade comprising first and second straight cutting edges, each including a plurality of cuts wherein a first cutting section oriented in a first direction is disposed on a first portion of the first straight cutting edge and a second portion of the second straight cutting edge respectively, and a second cutting section oriented in a second direction is disposed on a second portion of the first straight cutting edge and a first portion of the second straight cutting edge respectively.
